(19) United States
(12) Patent Application Publication
(10) Pub. No.: US 2004/0229046 A1
(43) Pub. Date: Nov. 18, 2004

(54) Aqueous vacuum-forming laminating adhesive composition containing polyether based plasticizers

(76) Inventors: Tien-Chieh Chao, Mars, PA (US); Umesh C. Desai, Wexford, PA (US); Masayuki Nakajima, Wexford, PA (US); Kaliappa G. Ragunathan, Gibsonia, PA (US); Shanti Swarup, Allison Park, PA (US)

Correspondence Address: PPG INDUSTRIES, INC., Intellectual Property Department, One PPG Place, Pittsburgh, PA, 15272, US

(21) Appl. No.: 10/436,005

(22) Filed: May 12, 2003

(51) Int. Cl. C08L 1/00

(52) U.S. Cl. 428/423.1; 524/366; 524/507

(57) ABSTRACT

An aqueous adhesive composition that includes an aqueous medium and a dispersed resinous phase containing a water dispersible polyurethane, a polymer that includes residues from a vinyl ester monomer, and a polyether containing compound as a plasticizer. The composition may be part of a multi-layer composite that includes a thermoplastic substrate, a thermoplastic cover layer, and an adhesive composition layered over at least a portion of the cover layer in contact with the substrate. The thermoplastic cover layer is adhered to the substrate by applying the adhesive composition to the cover layer, drying the composition forming a dried adhesive layer, heating the cover layer, contacting the dried adhesive layer on the cover layer to the substrate, and applying a vacuum to the substrate for a time and temperature sufficient to adhere the cover layer to the substrate.

### BACKGROUND OF THE INVENTION

1. Field of the Invention

The present invention relates to an aqueous vacuum-forming laminating adhesive composition. The adhesive composition is particularly useful for lamination of vinyl materials to thermoplastic substrates typically used in the automotive industry.

2. Description of Related Art

Vacuum-forming is a well-known process, particularly in the automotive industry. For example, a thermoplastic cover material (e.g., polyvinyl chloride and polyurethane flexible sheeting) can be laminated onto automobile components such as consoles, instrument panels, arm rests, door panels, and other interior surfaces using vacuum-forming process. The thermoplastic material has an outer side, which typically provides color and texture to the resulting laminated substrate, and an underside, which can further include a primer layer for enhanced adhesion to the substrate. Common substrates can include a variety of known materials, such as acrylonitrile-butadiene-styrene terpolymer (ABS) or fiberboard. The process typically includes coating a rigid substrate with a laminating adhesive, heating the thermoplastic material past its softening point, and draping the thermoplastic material onto the substrate. A vacuum is then applied through the substrate to pull the thermoplastic material onto the contours of the substrate, thereby forming a conformal layer of the thermoplastic cover material over at least a portion of the substrate.

In order to add efficiency to production methods, the adhesive can be pre-applied to the underside of the thermoplastic cover material by roll coating instead of spraying adhesive onto the rigid contoured substrate. Roll coating typically eliminates 40-50% of the waste generated from overspray in conventional spray application and in some cases, the manual labor associated with spraying. In addition, the roll coating method allows the precoated thermoplastic cover material to be stored for later application to a rigid substrate by vacuum application as described above. However, currently available adhesives exhibit poor adhesive strength when they are preapplied to thermoplastic cover materials and stored for later use.

Thus, it would be desirable to provide an aqueous-based, vacuum-formable laminating adhesive composition suitable for pre-application to thermoplastic cover materials which provides excellent adhesion to rigid substrates, while maintaining suitable heat and humidity resistance properties

### SUMMARY OF THE INVENTION

The present invention is directed to an aqueous adhesive composition that includes a resinous phase dispersed in an aqueous medium. The resinous phase contains:

(a) a water dispersible polyurethane;

(b) a polymer comprising residues from one or more vinyl ester monomers; and

(c) a plasticizer selected from the group consisting of polyether containing compounds having the following structures I-IV:

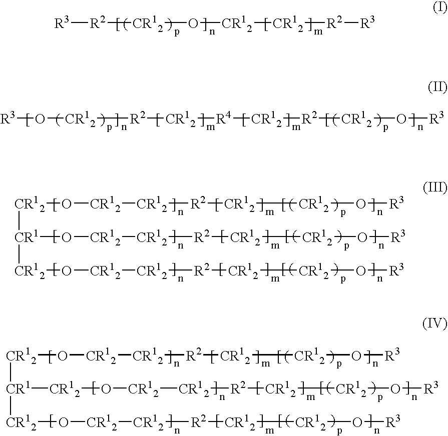

wherein each occurrence of R¹ is independently selected from H, a halide, and C₁-C₈ linear, cyclic, or branched alkyl; each occurrence of R² is independently a linking group selected from a covalent bond, —OCH₂—, —CH₂—, —NH—C (O)—NH—, —NH—C (O) —O—, —NH—C (O)—S—, —C (O)—O—, and —C(0)—NR⁸—, wherein R⁸ is selected from H and C₁-C₄ linear or branched alkyl; each occurrence of R³ is independently selected from H, and C₁-C₂₄ linear, cyclic, or branched alkyl, alkenyl, aryl, alkaryl, and aralkyl; each occurrence of R⁴ is independently selected from a C₁-C₂₄ linear, cyclic, or branched alkylene group, an oxyalkylene group containing from 1 to 24 carbon atoms, a C₁-C₂₄ linear, cyclic, and branched alkylene aryl group, a C₂-C₂₄ linear, cyclic, or branched alkenylene group, a C₂-C₂₄ linear, cyclic, or branched alkynylene group, an oxyalkenylene group containing from 2 to 24 carbon atoms, an oxyalkynylene group containing from 2 to 24 carbon atoms, a C₂-C₂₄ linear, cyclic, or branched alkenylene aryl group, a C₂-C₂₄ linear, cyclic, or branched alkynylene aryl group, a —O—[—(CR¹₂)ₚ—O—]ₙ— group where R¹ is defined as above, and a polyoxyalkylene group having a molecular weight of from 50 to 10,000; n is an integer of from 0 to 1,000; m is an integer from 0 to 6; and p is an integer from 0 to 6.

The present invention is further directed to a multi-layer composite that includes a thermoplastic substrate, the above-described adhesive layer over at least a portion of the substrate, and a thermoplastic cover layer over at least a portion of the adhesive layer.

The present invention is also directed to a method for adhering a vinyl material to a thermoplastic substrate. The method includes applying the above-described aqueous adhesive composition to at least a portion of the vinyl material, drying the composition to form a dried adhesive layer on the vinyl material, heating the thermoplastic material, contacting the dried adhesive layer on the vinyl material to the thermoplastic material, and applying a vacuum to the thermoplastic material for a time and at a temperature sufficient to adhere the vinyl material to said thermoplastic material.

### DETAILED DESCRIPTION OF THE INVENTION

Other than in the operating examples or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

Also, it should be understood that any numerical range recited herein is intended to include all sub-ranges subsumed therein. For example, a range of 1″ to 10″ is intended to include all sub-ranges between and including the recited minimum value of 1″ and the recited maximum value of 10″, that is, having a minimum value equal to or greater than 1″ and a maximum value of equal to or less than 10″.

As used herein and in the claims, the term “alkyl” refers to a monovalent linear, branched, or cyclic group derived from an alkane, typically having from 1 to 24 carbon atoms, non-limiting examples being CH₃—(methyl) and CH₃—CH₂—(ethyl).

As used herein and in the claims, the term “alkenyl” refers to a monovalent linear, branched, or cyclic group derived from an alkene, typically having from 2 to 24 carbon atoms, non-limiting examples being CH₂═CH₂—(ethenyl) and CH₂═CH—CH₂—CH₂—(butenyl).

As used herein and in the claims, the term “alkynyl” refers to a monovalent linear or branched group derived from an alkyne, typically having from 3 to 24 carbon atoms, non-limiting examples being C≡C—CH₂—(propynyl) and C≡C—CH₂—CH₂—(butynyl).

As used herein and in the claims, the term “aklylol” refers to an alkyl group where one or more hydrogen atoms have been substituted with a hydroxyl group.

As used herein and in the claims, the term “alkylene” refers to a linear or branched acyclic or cyclic alkanediyl group having a carbon chain length of from C₁ to C₂₅, typically from C₂ to C₁₂ and two free valences, a non-limiting example being —CH(CH₃)—CH₂—as propylene or propane-1,2-diyl. Other nonlimiting examples of suitable alkylene groups include, for example, —CH₂—CH₂—CH₂—(propylene or propane-1,3-diyl), —CH₂—CH₂—CH₂—CH₂—(butylene or butane-1,4-diyl), —CH₂—CH₂—CH₂—CH₂—CH₂—(pentylene or pentane-1,5-diyl) and —CH₂—(CH₂)₈—CH₂—(decylene or decane-1,10-diyl).

As used herein and in the claims, the term “oxyalkylene” refers to an alkylene group containing at least one oxygen atom bonded to, and interposed between, two carbon atoms, having two free valences, and having an alkylene carbon chain length of from C₂ to C₂₅, typically from C₂ to C₁₂. Nonlimiting examples of suitable oxyalkylene groups include those derived from ethylene glycol; propylene glycol; glycerol; allyl ethers of trimethylolpropane and pentaerythritol, for example, trimethylolpropane monoallyl ether, trimethylolpropane polyallyl ether, pentaerythritol monoallyl ether, and pentaerythritol polyallyl ether; polyethoxylated allyl alcohol; and polypropoxylated allyl alcohol, for example, —(CH₂)₃OCH₂C(CH₂OH)₂(CH₂CH₂) —; and mixtures thereof.

As used herein and in the claims, the term “alkylene aryl” refers to an acyclic alkylene group substituted with at least one aryl group, for example, phenyl, having two free valences, and having an alkylene carbon chain length of C₂ to C₂₅. The aryl group can be further substituted, if desired. Nonlimiting examples of suitable substituent groups for the aryl group include, but are not limited to, hydroxyl groups, benzyl groups, carboxylic acid groups, and aliphatic hydrocarbon groups.

As used herein and in the claims, the term “alkenylene” refers to an acyclic or cyclic hydrocarbon group having one or more double bonds, having two free valences, and having an alkenylene carbon chain length of C₂ to C₂₅.

As used herein and in the claims, the term “alkynylene” refers to an acyclic or cyclic hydrocarbon group having one or more triple bonds, having two free valences, and having an alkynylene carbon chain length of C2 to C25.

As used herein and in the claims, the term “oxyalkynylene” refers to an alkynylene group containing at least one oxygen atom bonded to, and interposed between two carbon atoms, having two free valences, and having an alkynylene carbon chain length of from C₂ to C₂₅ .

As used herein and in the claims, the term “alkynylene aryl” refers to an acyclic alkynylene group substituted with at least one aryl group, for example, phenyl, having two free valences, and having an alkynylene carbon chain length of C₂ to C₂₅. The aryl group can be further substituted, if desired, as described above with respect to the “alkylene aryl” groups.

As used herein and in the claims, the term “aryl” refers to a suitable aromatic group. Suitable aromatic groups falling within this term include, but are not limited to, phenyl, naphthyl, phenanthryl, phenalenyl, anthracenyl, triphenylenyl, fluoranthenyl, pyrenyl, pentacenyl, chrysenyl, naphthacenyl, hexaphenyl, picenyl, and perylenyl (preferably phenyl and naphthyl), in which each hydrogen atom may be substituted with methyl, a halide or group containing one or more of oxygen, nitrogen, and sulfur.

As used herein and in the claims, the terms “alkaryl” and “aralkyl” refer to aryl groups where one or more hydrogen atoms have been substituted with alkyl groups of from 2 to 20 carbon atoms; alkyl of from 1 to 20 carbon atoms in which each of the hydrogen atoms has been independently substituted with a halide (typically a fluoride or a chloride); alkenyl of from 2 to 20 carbon atoms; alkynyl of from 2 to 20 carbon atoms; alkoxy of from 1 to 6 carbon atoms; alkylthio of from 1 to 6 carbon atoms; C₃-C₈ cycloalkyl; halogen; —NH₂; C₁-C₆-alkylamino; C₁-C₆-dialkylamino; and phenyl which may be substituted with from 1 to 5 halogen atoms and/or C₁-C₄ alkyl groups.

As used herein and in the claims, the term “heterocyclyl” refers aromatic structures containing one or more non-carbon atoms (i.e. heteroatoms). Examples of heterocyclyl groups include, but are not limited to, pyridyl, furyl, pyrrolyl, thienyl, imidazolyl, pyrazolyl, pyrazinyl, pyrimidinyl, pyridazinyl, pyranyl, indolyl, isoindolyl, indazolyl, benzofuryl, isobenzofuryl, benzothienyl, isobenzothienyl, chromenyl, xanthenyl, purinyl, pteridinyl, quinolyl, isoquinolyl, phthalazinyl, quinazolinyl, quinoxalinyl, naphthyridinyl, phenoxathiinyl, carbazolyl, cinnolinyl, phenanthridinyl, acridinyl, 1,10-phenanthrolinyl, phenazinyl, phenoxazinyl, phenothiazinyl, oxazolyl, thiazolyl, isoxazolyl, isothiazolyl, and hydrogenated forms thereof known to those in the art.

As used herein and in the claims, the term “thermoplastic” refers to polymeric materials that may be repeatedly softened by heating and then hardened by cooling, and that may be shaped by applying heat and/or pressure. The term thermoplasic is meant to include polymeric materials having such physical properties, as well as such materials that further include commonly used additives, non-limiting examples of such additives include antioxidants, stabilizers, and fillers as are known in the art.

As used herein and in the claims the term “rigid thermoplastic substrate” refers to a thermoplastic material that is a noncrystalline solid at ambient conditions and at the processing conditions described herein. As used in the present invention, rigid thermoplastic substrates include, but are not limited to, rigid thermoplastic foams, acrylonitrile containing homopolymers and copolymers, expanded polystyrene, high impact polystyrene, rigid nylon, rigid polyurethanes, and rigid filled thermoplastics.

As used herein and in the claims, the terms “vinyl,” “vinyl plastic,” and “vinyl materials” refer to copolymers containing vinyl chloride and homopolymers of vinyl chloride, as well as composite materials that include vinyl chloride containing homopolymers and copolymers.

As indicated above, the present invention is directed to an aqueous adhesive composition that includes a resinous phase dispersed in an aqueous medium. The resinous phase includes (a) a water dispersible polyurethane, (b) a polymer that includes residues from one or more vinyl ester monomers, and (c) a plasticizer.

Any suitable water dispersible polyurethane may be used in the present invention. Among the suitable polyurethanes which may be used are those which generally are prepared by reacting polyester polyols or acrylic polyols such as those mentioned above with a polyisocyanate such that the NCO/OH equivalent ratio is greater than 1:1, typically resulting in free isocyanate groups being present in the product. The organic polyisocyanate which is used to prepare the polyurethane can be an aliphatic or an aromatic polyisocyanate or a mixture of the two. The polyurethanes can be prepared with unreacted carboxylic acid groups which, upon neutralization with bases such as amines, allows for dispersion into aqueous medium.

Suitable water dispersible polyurethanes may include ionic salt groups. The polyurethane polymer typically is dispersed in water prior to incorporation into the aqueous adhesive composition. The ionic salt groups present in the polyurethane polymer can facilitate dispersion of the polyurethane polymer into the aqueous medium. The polyurethane polymer can comprise either cationic or anionic salt groups. In an embodiment of the present invention, the polyurethane polymer comprises anionic salt groups. The polyurethane can be prepared by methods well known in the art, for example, by reaction of a polyisocyanate with a polyfunctional hydroxy compound (i.e., a polyol).

The polyisocyanates for preparing the polyurethane resin of the present invention can include aliphatic or aromatic isocyanates. Representative examples of aliphatic isocyanates include, but are not limited to, trimethylene; tetramethylene; pentamethylene; hexamethylene; 1,2-propylene; 1,2-butylene; 2,3-butylene; 1,3-butylene diisocyanates; the cycloalkylene compounds such as 1,3-cyclopentane, 1,4-cyclohexane, 1,2-cyclohexane diisocyanates and isophorone diisocyanates. Suitable aromatic isocyanates include, but are not limited to, m-phenylene, p-phenylene, 4,4′-diphenyl, 1,5-naphthalene, and 1,4-naphthalene diisocyanates; the aliphatic-aromatic compounds such as 4,4′-diphenylene methane, 2,4- or 2,6-tolylene, or mixtures thereof, 4,4′-toluidine, and 1,4-xylylene diisocyanates; the nuclear-substituted aromatic compounds such as dianisidine diisocyanate, 4,4′-diphenylether diisocyanate and chlorodiphenylene diisocyanate; the triisocyanates such as triphenyl methane-4,4′, 4″-triisocyanate, 1,3,5-triisocyanate benzene and 2,4,6-triisocyanate toluene; the tetraisocyanates such as 4,4′-dimethyldiphenyl methane-2,2′, 5,5′-tetraisocyanate; and polymerized polyisocyanates such as tolylene diisocyanate dimers and trimers, and the like.

Polyols useful in preparing the polyurethane of the present composition are typically hydroxyl terminated polyethers or polyesters. The polyethers are typically poly(oxyalkylene) derivatives of polyhydric alcohols, such as glycerol, trimethylolpropane, 1,2,6-hexanetriol, sorbitol, mannitol, pentaerythritol, or sucrose. Suitable polyesters are typically prepared from reaction of a carboxylic acid and a polyol, for example, reaction between adipic acid or phthalic acid and ethylene glycol, propylene glycol, 1,3-butylene glycol, 1,4-butylene glycol, diethylene glycol, 1,2,6-hexanetriol, trimethylolpropane, or trimethylolethane.

The polyurethane prepared by reacting a polyisocyanate with a polyfunctional hydroxy compound may also contain ionic groups to make the polyurethane water dispersible. In the case of an anionic resin, the ionic groups can be acid salt groups which may be selected from —OSO₃⁻, —OPO₃^{═}, COO⁻, SO₂O⁻, POO³¹ and PO₃^{═}. The polyurethane can be prepared with reactants containing the acid salt group, or, as is more normally the case, can be prepared with free acid groups which can be subsequently neutralized. Typically, the polyurethane is prepared having isocyanate groups capable of reacting with materials which contain at least one active hydrogen atom reactive with isocyanate groups or at least one isocyanate group; and at least one group capable of salt formation. Most often, the acid group is in the active hydrogen material because isocyanates containing acid groups typically are not stable.

Specific examples of compounds which contain active hydrogens and acid groups capable of salt formation are hydroxy and mercapto carboxylic acid. Examples include dimethylol propionic acid, glycolic acid, thioglycolic oxalauric acid, lactic acid, malic acid, dihydroxy malic acid, tartaric acid, dihydroxy tartaric acid, and 2,6-dihydroxybenzoic acid. Other examples of compounds which contain active hydrogens and acid groups are aminocarboxylic acids, aminohydroxy carboxylic acids, sulfonic acids, hydroxy sulfonic acids, and aminosulfonic acids. Examples include anilido acetic acid, glycine, alpha-alanine, 6-amino caproic acid, reaction product of ethanolamine and acrylic acid, hydroxy ethyl propionic acid, 2-hydroxyethane sulfonic acid, and sulphanilic acid. As mentioned above, amino acids typically are used in the presence of a base such as KOH or a tertiary amine. Other examples include bis-hydroxymethylphosphinic acid, trimethylol propane monophosphate and monosulfate, N-hydroxyethyl-aminoethylphosphonic acid. Suitable salt forming agents for acid group-containing compounds include inorganic and organic bases such as sodium hydroxide, potassium hydroxide, ammonia, and tertiary amines.

Suitable anionic salt group-containing polyurethane polymers are described in U.S. Pat. No. 5,430,094 to Gola et al.

In an embodiment of the present invention, the polyurethane is anionic and includes carboxylated groups, sulfonated groups, or mixtures thereof. Anionic polyurethanes that may be used in the present invention include, but are not limited to, those sold under the trade designations Luphen® D 200, Luphen®D 207 E, and Luphen® DDS 3528 (BASF Corporation, Charlotte, N.C.), and Dispercoll™ U-53 (Bayer Corporation, Pittsburgh, Pa.).

Besides acid salt groups which are anionic, the polyurethane alternatively can comprise cationic salt groups such as those which can be selected, for example, from quaternary ammonium groups, phosphonium groups, sulfonium groups, and mixed groups thereof. The polyurethane can be prepared with reactants containing the cationic salt groups, or as is more normally the case, polyurethanes containing suitable precursors can be converted to the cationic salt by adding an acid to the prepolymer. Suitable materials for introducing cationic groups into the polyurethane are materials which contain at least one active hydrogen atom reacted with isocyanate groups, or at least one isocyanate group and at least one group capable of cationic salt formation.

Other suitable cationic salt group-containing polyurethane polymers include those polyurethane polymers prepared by chain extending an isoycanate functional urethane prepolymer with polyamine and ketimine. Such polyurethane polymers are described in detail in U.S. Pat. No. 5,652,299 to Nakajima et al., column 3, line 1 to column 5, line 29, incorporated herein by reference.

The water dispersible polyurethane can have a number average molecular weight of at least 500, in some cases at least 1,000 and in other cases at least 1,500. Also, the number average molecular weight of the water dispersible polyurethane may be up to 50,000, in some cases up to 40,000, in other cases up to 30,000, in some situations up to 20,000, in other situations up to 10,000, and in some circumstances up to 5,000 as determined by gel permeation chromatography using polystyrene standards. The number average molecular weight of the polyurethane polymer present in the aqueous adhesive composition of the present invention can range between any combination of these values, inclusive of the recited values. Mixtures of any of the previously described water-dispersible polyurethanes can be used.

The water dispersible polyurethane can be present in the resinous phase of the aqueous adhesive composition of the present invention in an amount of at least 0.1 weight percent, often at least 1 weight percent, in some cases at least 5 weight percent, in other cases at least 10 weight percent, in some situations at least 15 weight percent, and in other situations at least 20 weight percent based on total weight of resin solids present in the composition. Also, the polyurethane polymer can be present in the aqueous adhesive composition of the present invention in an amount of not more than 70 weight percent, often not more than 60 weight percent, in some cases not more than 50 weight percent, in other cases not more than 40 weight percent, and in some situations not more than 30 weight percent based on total weight of resin solids present in the composition. The amount of polyurethane polymer present in the aqueous adhesive composition of the present invention can range between any combination of these values, inclusive of the recited values.

Any suitable polymer that includes residues from one or more vinyl ester monomers may be used in the present invention. Suitable polymers include, but are not limited to, homopolymers and copolymer of vinyl acetate.

In an embodiment of the present invention, the polymer that includes residues from a vinyl ester monomer includes a vinylacetate-ethylene copolymer. Non-limiting examples of copolymers that may be used in this embodiment include those described in U.S. Pat. Nos. 4,921,898 to Lenney et al., 5,070,134 to Oyamada et al., and 6,245,851 to Petrocelli et al. Particular non-limiting examples of suitable vinylacetate-ethylene copolymers include those available under the trade name AIRFLEX® from Air Products and Chemicals, Inc., Allentown, Pa. Mixtures of any of the previously described polymers containing residues of one or more vinyl ester monomers can be used.

The polymer that includes residues from one or more vinyl ester monomers has a number average molecular weight of at least 500, in some cases at least 1,000, and in other cases at least 1,500. Also, the number average molecular weight of the polymer that includes residues from one or more vinyl ester monomers may be up to 50,000, in some cases up to 40,000, in other cases up to 30,000, in some situations up to 20,000, in other situations up to 10,000, and in some circumstances up to 5,000 as determined by gel permeation chromatography using polystyrene standards. The number average molecular weight of the polymer that includes residues from one or more vinyl ester monomers present in the aqueous adhesive composition of the present invention can range between any combination of these values, inclusive of the recited values.

The polymer that includes residues from one or more vinyl ester monomers can be present in the resinous phase of the aqueous adhesive composition of the present invention in an amount of at least 0.1 weight percent, often at least 1 weight percent, in some cases at least 5 weight percent, and in other cases at least 10 weight percent based on total weight of resin solids present in the composition. Also, the polymer that includes residues from a vinyl ester monomer can be present in the aqueous adhesive composition of the present invention in an amount of not more than 70 weight percent, often not more than 60 weight percent, in some cases not more than 50 weight percent, in other cases not more than 40 weight percent, and in some situations not more than 30 weight percent based on total weight of resin solids present in the composition. The amount of polymer that includes residues from one or more vinyl ester monomers present in the aqueous adhesive composition of the present invention can range between any combination of these values, inclusive of the recited values.

The plasticizer suitable for use in the composition of the present invention includes a polyether containing compound having structure I, structure II, structure III, structure IV, and mixtures thereof:

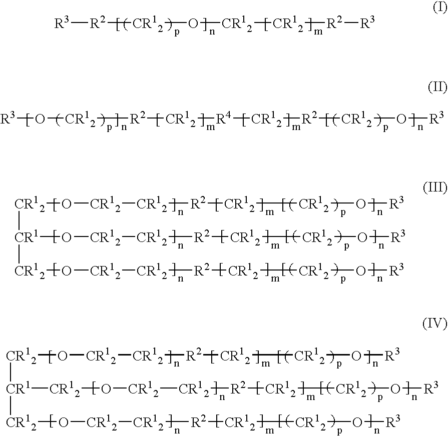

where each occurrence of R¹ is independently selected from H, a halide, and C₁-C₈ linear, cyclic, or branched alkyl; each occurrence of R² is independently a divalent linking group selected from a covalent bond, —OCH₂—, —CH₂—, —NH—C(O)—NH—, —NH—C(O)—O—, —NH—C(O)—S—, —C(O) —O—, —C(O)—NR⁸—, where R⁸ is selected from H and C₁-C₄ linear or branched alkyl; each occurrence of R³ is independently selected from H, and C₁-C₂₄ linear, cyclic, or branched alkyl, alkenyl, aryl, alkaryl, and aralkyl; each occurrence of R⁴ is independently selected from a C₁-C₂₄ linear, cyclic, or branched alkylene group, an oxyalkylene group containing from 1 to 24 carbon atoms, a C₁-C₂₄ linear, cyclic, or branched alkylene aryl group, a C₂-C₂₄ linear, cyclic, or branched alkenylene group, a C₂-C₂₄ linear, cyclic, or branched alkynylene group, an oxyalkenylene group containing from 2 to 24 carbon atoms, an oxyalkynylene group containing from 2 to 24 carbon atoms, a C₂-C₂₄ linear, cyclic, or branched alkenylene aryl group, a C₂-C₂₄ linear, cyclic, or branched alkynylene aryl group, a —O—[—(CR¹₂)ₚ—O—]ₙ— group where R¹ is defined as above, and a polyoxyalkylene group. When R⁴ is a polyoxyalkylene group, the polyoxyalkylene group may have a number average molecular weight of at least 50, in some cases at least 100, in other cases at least 200, in some situations at least 250, and in other situations at least 500. Also, when R⁴ is a polyoxyalkylene group, the polyoxyalkylene group may have a number average molecular weight of up to 10,000, in some cases up to 7,500, in other cases up to 5,000, in some situations up to 4,000, in other situations up to 3,000, in some circumstances up to 2,500, and in other circumstances up to 2,000. The number average molecular weight of the polyoxyalkylene group of R⁴ may be determined by either high pressure liquid chromatography, liquid chromatography, or gel permeation chromatography using polystyrene standards. The number average molecular weight of the polyoxyalkylene group of R⁴ can range between any combination of these values, inclusive of the recited values.

In structures I-IV, each ocurrence of n can be zero and can independently be an integer of at least 1, in some cases at least 2, in other cases at least 3, in some situations at least 4 and in other situations at least 5. Also, the integer n may be up to 1,000, in some cases up to 750, in other cases up to 500, in some situations up to 250, in other situations up to 100, in some circumstances up to 50, and in other circumstances up to 25. The value of the integer n for structures I-IV can range between any combination of these values, inclusive of the recited values.

In structures I and II, each ocurrence of m independently may be zero or an integer of at least 1, and in some cases at least 2. Also, the integer m may be up to 6, in some cases up to 5, in other cases up to 4, and in some situations up to 3. The value of the integer m for structures I and II can range between any combination of these values, inclusive of the recited values.

In structures I and II, each ocurrence of p can be zero and can independently be an integer of at least 1, and in some cases at least 2. Also, the integer p may be up to 6, in some cases up to 5, in other cases up to 4, and in some situations up to 3. The value of the integer p for structures I and II can range between any combination of these values, inclusive of the recited values.

The polyether portion of the compounds of structures I and II may be obtained from any suitable polyether containing compound. Suitable polyethers from which the polyether portion is derived typically include poly(oxyalkylene) derivatives of polyhydric alcohols. Specific suitable polyether containing compounds include, but are not limited to, homopolymers and copolymers of ethylene glycol, propylene glycol, glycerol, trimethylolpropane, 1,2,6-hexanetriol, sorbitol, mannitol, pentaerythritol, sucrose, and mixtures thereof. The polyethers may have hydroxyl terminal groups, amine terminal groups or mixtures thereof.

Examples of poly(oxyalkylene) derivatives that include amine functional terminal groups include, but are not limited to, those disclosed in U.S. Pat. Nos. 3,236,895 to Lee et al.; 3,654,370 to Yeakey; and 4,075,130 to Naylor et al. Examples of poly(oxyalkylene) derivatives that include amine functional and hydroxy functional terminal groups include, but are not limited to, the JEFFAMINE® M-series products, available from Huntsman, LLC, Houston, Tex. Examples of poly(oxyalkylene) derivatives that include diamine functionality include, but are not limited to, the JEFFAMINE® D-series products available from Huntsman. Examples of poly(oxyalkylene) derivatives that include triamine functionality include, but are not limited to, the JEFFAMINE® T-series products available from Huntsman.

Examples of poly(oxyalkylene) derivatives that include dihydroxy functionality include, but are not limited to, the PLURONIC® series of products available from BASF; the CARBOWAX® polyethylene glycol and methoxy polyethylene glycol products available from the Dow Chemical Company, Midland, Mich.; and the polypropylene glycol products available from Bayer Corporation, Pittsburgh, Pa.

Suitable polyether containing plasticizers can be prepared by reacting one or more polyethers having amine and/or hydroxyl funtional groups with a compound containing one or more suitable reactive groups. Suitable reactive groups include, but are not limited to, mono-, di-, tri-, and poly-functional compounds containing one or more isocyanate groups, isothiocyanate groups, carboxylic acids, carboxylic acid chlorides, and carboxylic acid anhydrides. The combinations of reactive functional groups and the amine and/or hydroxyl funtional groups of the polyethers provide the linking groups, R², which can include urethanes, thiourethanes, esters, thioesters, ureas, and amides.

In an embodiment of the present invention, the polyether containing plasticizer is prepared by reacting one or more polyoxyalkalene polyamines with an aromatic isocyanate, where the aromatic group is selected from phenyl, napthyl, benzyl, and anthracenyl.

In a futher embodiment of the present invention, the polyether containing plasticizer is prepared by reacting one or more polyisocyanates with a monofunctional (i.e. containing a single hydroxyl group or amine group) polyoxyalkylene material.

The polyether-containing plasticizer is typically a liquid at ambient conditions and has a number average molecular weight of at least 100, in some situations 200, in some cases at least 300, and in other cases at least 500. Also, the number average molecular weight of the polyether containing plasticizer may be up to 10,000, in some cases up to 7,500, in other cases up to 5,000, in some situations up to 4,000, in other situations up to 3,000, and in some circumstances up to 2,500 as determined by either high pressure liquid chromatography, liquid chromatography, or gel permeation chromatography using polystyrene standards. The number average molecular weight of the polyether containing plasticizer present in the aqueous adhesive composition of the present invention can range between any combination of these values, inclusive of the recited values. Mixtures of any of the previously described plasticizers can be used.

The plasticizer can be present in the resinous phase of the aqueous adhesive composition of the present invention in an amount of at least 0.1 weight percent, often at least 0.25 weight percent, in some cases at least 0.5 weight percent, in other cases at least 1.0 weight percent based on total weight of resin solids present in the composition. Also, the plasticizer can be present in the aqueous adhesive composition of the present invention in an amount of not more than 20 weight percent, often not more than 15 weight percent, in some cases not more than 12.5 weight percent, in other cases not more than 10 weight percent, and in some situations not more than 7.5 weight percent based on total weight of resin solids present in the composition. The amount of plasticizer present in the aqueous adhesive composition of the present invention can range between any combination of these values, inclusive of the recited values.

In addition to the polyether containing plasticizer described above, the aqueous adhesive composition may contain other plasticizers known in the art. In an embodiment of the present invention, the aqueous adhesive composition includes N-n-butylbenzenesulfonamide (BBSA) in addition to the polyether containing plasticizer.

The aqueous adhesive composition of the present invention may further include an adjuvant selected from carbodiimide, aziridine, azetidinols, and mixtures thereof. As used herein, the term “aziridine” refers to any alkyleneimine and includes any compound comprising more than one of the following structural units (V):

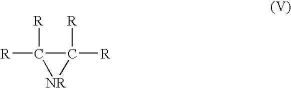

where each R independently represents H, cyclic or acyclic alkyl, alkaryl, aralkyl, or a divalent linking group such as alkylene, oxyalkylene, alkylene aryl, alkenylene, oxyalkenylene, and alkenylene aryl, provided that at least one R is a divalent linking group.

Suitable alkylene groups are typically acyclic or cyclic saturated hydrocarbon groups having a carbon chain length of from C₁ to C₂₅, typically from C₂ to C₁₂. Nonlimiting examples of suitable alkylene groups include for example, —(CH₂)₃—, —(CH₂)₄—, —(CH₂)₅—, and —(CH₂)₁₀—. Suitable oxyalkylene groups are typically alkylene groups containing at least one oxygen atom bonded to, and interposed between, two carbon atoms and having an alkylene carbon chain length of from C₂ to C₂₅, typically from C₂ to C₁₂. Nonlimiting examples of suitable oxyalkylene groups include those derived from allyl ethers of trimethylolpropane and pentaerythrito, for example, trimethylolpropane polyoallyl ether, pentaerythritol polyoallyl ether, polyethoxylated allyl alcohol, and polypropoxylated allyl alcohol, such as, for example, —(CH₂)₃OCH₂C (CH₂OH)₂(CH₂CH₂) —.

Suitable alkylene aryl groups are typically acyclic alkylene groups substituted with at least one aryl group, for example, phenyl, and having an alkylene carbon chain length of C₂ to C₂₅. The aryl group can be further substituted, if desired. Nonlimiting examples of suitable substituent groups for the aryl group include, but are not limited to, hydroxyl groups, benzyl groups, carboxylic acid groups, and aliphatic hydrocarbon groups.

As used herein and in the claims, the term “carbodiimide” refers to carbodiimide and substituted carbodiimides. Suitable carbodiimides that may be used in the present invention further include, but are not limited to, those described in U.S. Pat. Nos. 5,108,653 to Taylor and 4,487,964 to Watson, Jr. et al., as well as UCARLINK XL 29SE which has a solids content of 50 percent and is commercially available from Dow Chemical Co., and water-based carbodiimides such as CARBODILITE® available from GSI Exim America, Inc., New York, N.Y.

As used herein, the term “azetidinol” refers to compounds containing one or more groups described by structure VI:

Suitable azetidinols that may be used in the present invention include, but are not limited to those disclosed in U.S. Pat. Nos. 5,349,006 (col. 4, line 28 to col. 5, line 62), 5,276,166 (col. 2, line 15 to line 64), 5,296,541 (col. 2, line 15 to line 51), and 5,324,789 (col. 4, line 15 to col. 5, line 4) all to Swarup et al., the disclosures of which are incorporated herein by reference.

The aziridine and/or carbodiimide and/or azetidinol can be present in the resinous phase of the aqueous adhesive composition of the present invention in an amount of at least 0.1 weight percent, often at least 0.25 weight percent, in some cases at least 0.5 weight percent, in other cases at least 0.75 weight percent, and in some situations at least 1.0 weight percent based on total weight of resin solids present in the composition. Also, the aziridine and/or carbodiimide and/or azetidinol can be present in the aqueous adhesive composition of the present invention in an amount of not more than 10 weight percent, often not more than 7.5 weight percent, in some cases not more than 5 weight percent, in other cases not more than 3 weight percent, in some situations not more than 2 weight percent, and in other situations not more than 1.5 weight percent based on total weight of resin solids present in the composition. The amount of aziridine and/or carbodiimide and/or azetidinol present in the aqueous adhesive composition of the present invention can range between any combination of these values, inclusive of the recited values.

In an embodiment of the present invention, the aziridine may be a polyfunctional aziridine curing agent. Such polyfunctional aziridines may include trimethylolpropane-tris-(β-(N-aziridinyl)propionate), and pentaerythritol-tetra-(62 -(N-aziridinyl)propionate).

The aziridine compound which can be present in the composition of the present invention can be present in the composition in an amount ranging from 0.1 to 1.5 weight percent, usually from 0.2 to 1 weight percent, and typically from 0.4 to 0.8 weight percent based on total weight of resin solids present in the composition. Useful polyfunctional aziridine compounds include, but are not limited to, those available commercially from Bayer Corporation of Pittsburgh, Pa. as XAMA-220 and XAMA-7.

The aqueous adhesive composition of the present invention may optionally include a rubber-type material in the resinous phase of the composition. As used herein and in the claims, the term “rubber-type material” refers to a synthetic or naturally occuring material with elastomeric bulk properties. Suitable rubber-type materials that may be included in the present invention include, but are not limited to, silicone rubbers, such as polysiloxanes; natural rubber; and synthetic rubbers, such as neoprene, ABS rubber, styrene-butadiene rubber (SBR), EPR (ethylene-propylene rubber) and nitrile rubber. In an embodiment of the present invention, the rubber-type material is selected from polysiloxanes, EPR, SBR, and ABS rubber.

Any of the afore-described aqueous adhesive compositions of the present invention optionally also can include other additives as are well known in the adhesives art, for example, plasticizers such as a butyl benzene sulfonamide, as discussed above, and diluents such as propylene glycol. Such compounds and other similar compounds are useful, for example, as wetting agents, flow modifiers, catalysts, and fillers. Other additives can include, if desired, such materials as polyvinylidene chloride, polyvinyl acetate, polyvinyl chloride, copolymers thereof, and mixtures thereof.

As discussed above, the present composition is an aqueous adhesive composition. The composition can include water in an amount of at least 25 weight percent, in some cases at least 35 weight percent, in other cases at leat 40 weight percent, and in some situations at least 45 weight percent. Also, the composition can include water in an amount of up to 75 weight percent, often up 60 weight percent, and in some cases up to 55 weight percent based on total weight of the aqueous adhesive composition.

It should be understood that the aforementioned adhesive compositions are storage stable and suitable for use as a single-component or “one pack” composition, that is, a composition in which all the ingredients are combined substantially prior to application without the occurrence of gelation and without an unacceptable increase in viscosity over time upon storage at a given temperature. For example, an unacceptable increase in viscosity is one which requires the addition of an amount of organic solvent and/or water sufficient to decrease the composition to spray viscosity effects an unacceptable drop in composition solids.

The aqueous composition of the present invention is formulated to readily flow at room temperature and is sufficiently viscous to promote stability and minimize phase separation of the composition. As such, the present aqueous composition typically has an initial viscosity of at least 100 centipoise (cps), in some cases at least 250 cps, in other cases at least 500 cps, in some situations at least 700 cps, and in other situations at least 800 cps. Also, the initial viscosity of the present aqueous composition may be up to 10,000 cps, in some cases up to 7,500 cps, in some situations up to 5,000 cps, and in other situations up to 2,500 cps. The initial viscosity of the present aqueous composition may be measured using a Brookfield viscometer with a number 3 spindle (or other appropriate spindle) at 20 rpm and ambient temperature.

The aqueous compositions of the present invention can have less than 100 percent gain in viscosity, usually not more than a 75 percent gain in viscosity, and typically not more than a 50 percent gain in viscosity after 30 days storage at ambient temperature (viscosity being measured as described above). Ambient temperature is considered to be not more than 28° C., and more typically 25° C. It should be noted that stability of the present composition is determined at ambient temperatures and that at accelerated times and temperatures, such viscosity characteristics may differ.

In one embodiment, the present invention is directed to a multi-layer composite comprising (1) a thermoplastic substrate; (2) an adhesive layer over at least a portion of the substrate; and (3) a thermoplastic cover layer over at least a portion of the adhesive layer. The adhesive layer can be formed from any of the previously discussed aqueous adhesive compositions. In an embodiment of the present invention, the adhesive layer is formed from the previously described aqueous adhesive composition comprising a resinous phase dispersed in an aqueous medium, where the resinous phase comprises (a) a water dispersible polyurethane; (b) a polymer that includes residues from a vinyl ester monomer; and (c) a plasticizer. The polyurethane polymer (a) is present in the aqueous adhesive composition in an amount sufficient to provide adhesion of the cover layer (3) to the substrate (1) such that the multi-layer composite provides sufficient adhesive strength to bond the cover layer (3) to the substrate (1).

For purposes of the present invention, the adhesive strength is typically measured using the Hanging Weight Test Method. In this test method, test strips (typically 4.5 inches by 6 inches) having a vinyl (poly(vinyl chloride (PVC))) cover and a polyethylene (PE) foam back are coated with adhesive by draw down with a 6 mil (150 micrometers) draw bar. The vinyl strips are air dried for 15-20 minutes followed by a dehydration bake for seven minutes at 70° C. and cooled. The strips are then heated in a 177° C. oven for one minute and immediately placed over a 4 inches by 6 inches plaque of acrylonitrile-butadiene-styrene (ABS) resin and the assembly is bonded with a Carver press (Carver Press Model 2697) preheated to 54 to 60° C., with 14.6 pounds per square inch for 11 seconds.

The bonded test strips are placed in a test frame for hanging weight peel resistance at 88° C. as a function of time. A 150 gram weight is clipped onto the laminate sample and permitted to hang at an angle slightly offset from the plane of the test strip. The location of separation between the substrate and the laminate layer is marked and the sample placed into an oven at 88° C. The new location of the separation is marked after five hours to determine the separation distance. A sample is considered to “pass” the test if the separation distance is less than 30 mm and to “fail” the test if the laminate peeled off or the separation distance is greater than 30 mm.

The aqueous adhesive composition of the present invention does not fail after five hours of the Hanging Weight Test Method peel resistance at after five hours at 88° C., and in this test, the aqueous adhesive composition of the present invention minimizes movement to a separation distance of less than 30 mm, in some cases less than 20 mm, and in other cases less than 10 mm. Additionally, the present aqueous adhesive composition does not fail after five hours of the Hanging Weight Test Method peel resistance at 85° C. at 60% relative humidity (RH). In this test, the aqueous adhesive composition of the present invention minimizes movement to a separation distance of less than 30 mm, in some cases less than 20 mm, and in other cases less than 10 mm.

As previously discussed, the substrate (1) can be any rigid thermoplastic substrates known in the art including, but not limited to, thermoplastic substrate that include synthetic rubbers, polyurethanes, polyolefins, polyesters, and polyamides.

In a particular embodiment of the present invention, the substrate is a rigid substrate, typically a rigid synthetic rubber or rigid polyurethane substrate. Nonlimiting examples of suitable rigid substrates include those formed from ABS rubber, SBR, polyethylene, polypropylene, thermoplastic polyolefin (“TPO”), reaction injected molded polyurethane (“RIM”), thermoplastic polyurethane (“TPU”), or combinations of the foregoing materials. In one embodiment of the present invention, the substrate (1) comprises a rigid ABS substrate.

The substrate can be untreated or treated, for example by corona or plasma treatment techniques. In an embodiment of the present invention, the substrate is untreated.

The thermoplastic cover layer can be any flexible film cover material, such as those used in the production of laminates, known to those skilled in the art. Such materials can include, without limitation, polyurethane, polyolefin, polyvinyl, polyvinyl chloride materials, and combinations thereof.

In one embodiment, the present invention is directed to a method for adhering a thermoplastic material to a rigid substrate, typically a substrate such as those described above, where the adhesive has been preapplied. The method comprises the steps of (1) providing a thermoplastic material (such as any of the thermoplastic cover materials described above) having a top surface and a bottom surface; (2) applying an aqueous composition as described above and including a resinous phase dispersed in an aqueous medium, the resinous phase including (a) a water dispersible polyurethane, (b) a polymer that includes residues from one or more vinyl ester monomers, and (c) a plasticizer, to the bottom surface of the thermoplastic material; (3) drying the composition to form a dried adhesive layer on the bottom surface of the thermoplastic material; (4) heating the thermoplastic material of step (3) separate from the substrate; (5) contacting the adhesive layer on the bottom surface of the thermoplastic material to the rigid substrate; and (6) applying a vacuum to the substrate of step (5) for a time and at a temperature sufficient to adhere the thermoplastic material to the substrate.

When the present adhesive composition is preapplied to a cover material and later vacuum formed to a substrate, excellent adhesion of the cover material to the substrate is observed. This method has the time saving advantage of eliminating the steps of applying adhesive to the substrate during assembly operations. Typically, the adhesive is preapplied to the cover material, stored, and later used in assembly operations. In a particular emobodiment of the present invention, the adhesive has a storage stability of six months at room temperature or ambient conditions, and the cover with preapplied adhesive can be readily applied to a substrate as described above after storage of 30 days.

In an embodiment of the present invention, the rigid substrate is selected from ABS and polyurethane substrates, and the thermoplastic material includes a vinyl material.

The aforementioned methods of the present invention include applying the aqueous adhesive composition to the substrate or, alternatively, to the undersurface of the thermoplastic cover material, or both. Application can be achieved in any manner known to those skilled in the art, and includes, for example, spraying the adhesive onto the substrate, or alternatively, spraying or roll coating the adhesive composition onto the bottom surface of the thermoplastic cover material, or applying the adhesive both onto the substrate and onto the bottom suface of the thermoplastic cover material. The adhesive typically is applied at film thicknesses ranging from 1 to 15 mils (25 to 375 micrometers), and more typically from 5 to 10 mils (125 to 250 micrometers).

The adhesive composition then typically is dried on the substrate or, alternatively, on the bottom surface of the thermoplastic cover material, or both. Drying can be achieved by allowing the coated substrate or thermoplastic material to air dry at room temperature or by actively drying the composition with elevated temperatures. Depending on the temperature, humidity, and film thickness, drying of the composition can take from several minutes to one hour or more. For example, a film at a thickness of about 5 mils (125 micrometers) can be dried in a 70° C. oven in about 3 to 5 minutes.

After drying the composition or during the drying of the composition, the thermoplastic cover material is heated separate from the substrate to soften the cover material. Typically, the thermoplastic cover material is heated to a temperature ranging from 110° C. to 180° C. The heated cover material is then contacted to the dried adhesive composition on the surface of the substrate or, alternatively, the dried adhesive composition on the bottom surface of the thermoplastic cover material is contacted to the surface of the substrate. Most typically, the material is contacted by draping the heated flexible cover material onto the substrate.

A vacuum is then applied to the flexible cover material over the substrate to draw the material into all recessed areas of the substrate, thereby forming a conformal thermoplastic cover layer over at least a portion of the substrate. Typically, the vacuum is drawn for at least 10 seconds, but the time can vary dependent on the substrate size and shape. In the case of substrates which are not porous, holes can be made in the substrate so that a vacuum can pull the flexible material onto the substrate. In the case of porous materials, a vacuum can be achieved directly through the substrate without placing holes in the substrate.

Subsequent to application of a vacuum, the aqueous adhesive composition will cure at room temperature. Cure can be accelerated by heating the laminated substrate. As used herein, the term “cure” (or “curing”) is intended to include both crosslinking of the adhesive composition components as well as adhesive film formation as a result of evaporation of water and, if present, other diluents along with the development of physical and chemical properties in the resultant film, such as bond strength.

As mentioned above, the aqueous adhesive composition can vary and be modified to meet less stringent or more stringent adhesive requirements depending upon the end use application. For example, for non-automotive applications or applications where the peel strength testing described above is not applicable, alternative embodiments of the adhesive compositions may meet the designated requirements.

Illustrating the invention are the following examples that are not to be considered as limiting the invention to their details. All parts and percentages in the examples, as well as throughout the specification, are by weight unless otherwise indicated.

### EXAMPLES A, B, AND C

### Example A

### Preparation of a Hydroxy Functional Polyether Urethane.

2,000 g of Jeffamine D-400 (polyether diamine from Huntsman) and 968 g of ethylenecarbonate were added to a reaction vessel and heated to 130° C. The reaction mixture was held at this temperature until greater than 90% of the amine was reacted as measured by potentiometric titration. The product was slightly yellowish. The solids of the sample were 94 wt.%, measured at 110° C. for 1 hour. The weight averaged molecular weight of the sample was 800 as measured by gel permeation chromatography using polystyrene as standards.

### Example B

### Preparation of a Phenyl Urea Derivative of a Polyether Amine.

To a four neck round bottom flask fitted with reflux condenser, thermocouple, agitator, and nitrogen inlet, 0.33 moles of Jeffamine M-600 (polyether monoamine from Huntsman) was added. To the stirred solution of Jeffamine M-600 under nitrogen atmosphere, phenyl isocyanate (0.3 moles) was added over a one-hour period. After 30 minutes, the temperature of the reaction mixture was raised to 80° C. and held at that temperature until no isocyanate groups were detected by IR spectroscopy at 2260 cm ⁻. The presence of urea groups was confirmed by IR spectroscopy. The resulting urea derivative was cooled to ambient temperature.

### Example C

### Preparation of an Acetic Acid Ester of Polypropylene Oxide.

213.3 g of PPG-425 (polypropylene oxide available from Bayer Corporation), 102.1 g of acetic anhydride, 300 g of methyl isobutyl ketone, and 3 g of sodium acetate were added into a 2-L flask. The flask was heated to reflux, and the mixture was stirred under reflux for 6 hours. The reaction mixture was cooled to room temperature, and was transferred to a 5-L three-neck round bottom flask. 300 g of methyl isobutyl ketone was added to the flask. 1000 g of 4% aqueous sodium hydroxide solution was added to the flask. The resulting mixture was stirred vigorously for 15 minutes. The mixture was then transferred into a separatory funnel. An aqueous layer was formed and removed. The remaining organic layer was washed with 400 g of water. The aqueous layer was separated and discarded. The organic layer was poured into a 2-L three-neck round bottom flask. Solvents were removed by vacuum distillation to yield colorless liquid. An IR spectrum indicated the presence of ester group and the absence of hydroxyl groups.

### EXAMPLES 1 THROUGH 7

The following Examples 1 through 7 describe the preparation of various aqueous adhesive compositions of the present invention. The ingredients for each of the Examples 1 through 7 are shown in Table 1 and were added sequentially under mild agitation to a suitably sized mixing vessel and mixed until thoroughly blended.

TABLE 1

| Ingredient | Example 1 | Example | Example | Example | Example | Example |
|---|---|---|---|---|---|---|
| (g) | (Comparative) | 2 | 3 | 4 | 5 | 6 |
| LUPHEN | 52.16 | 52.67 | 52.67 | 52.55 | 52.67 | 52.67 |
| D 207 E¹ | | | | | | |
| AIRFLEX | 37.26 | 37.62 | 37.62 | 37.54 | 37.62 | 37.62 |
| 460² | | | | | | |
| PLASTHALL | 6.48 | — | — | — | — | — |
| BSA³ | | | | | | |
| Urethane | — | 5.57 | — | — | — | — |
| of Example | | | | | | |
| A | | | | | | |
| Urea of | — | — | 5.57 | — | — | — |
| Example B | | | | | | |
| Diester of | — | — | — | 5.78 | — | — |
| Example C | | | | | | |
| Pluronic | — | — | — | — | 5.57 | — |
| L31⁵ | | | | | | |
| PPC-425⁴ | — | — | — | — | — | 5.57 |
| XAMA 220⁶ | 0.63 | 0.64 | 0.64 | 0.64 | 0.64 | 0.64 |
| UCARLINK | 3.31 | 3.34 | 3.34 | 3.33 | 3.34 | 3.34 |
| XL29SE⁷ | | | | | | |
| AKROSPERSE | 0.16 | 0.16 | 0.16 | 0.16 | 0.16 | 0.16 |
| E98⁸ | | | | | | |

¹Aqueous polyurethane dispersion, available from BASF, Inc.
²Poly (vinylacetate-ethylene) emulsion, available from Air Products & Chemicals.
³N-n-Butylbenzene sulfonamide, available from C. P. Hall Co.
⁴Poly(propylene glycol), available from Bayer Corp.
⁵Poly(ethylene oxide-propylene oxide), available from BASF, Inc.
⁶Polyfunctional aziridine, 100% solids by weight, available from Bayer Corp.
⁷Carbodiimide solution, 50% solids by weight, available from Dow Chemical Co.
⁸Blue dye, 35% solids by weight, available from Akrochem Inc.

The following Example 7 is a comparative of a typical aqueous adhesive composition, which was prepared as described in Example 2 of WO 98/45366. Specifically, the following ingredients were combined:

44 g Urethane dispersion, Zeneca R-9621 available from Zeneca, Wilmington, Mass.;

33 g Urethane dispersion, Zeneca R-9617 available from Zeneca;

0.01 g 1,2-benzisothiazolin-3-one;

0.01 g Foam control agent, Dreplus L-407, Ahland Chemical, Boonton, N.J.;

0.01 g Blue dye, Aquasperse 11977-7226, HÜLS America, Piscataway, N.J.;

0.33 g Rheology modifier, Nopco DSX-1550, Henkel, Ambler, Pa.;

20.4 g Carboxy-modified reactive acrylic latex, Hycar 26084, B F Goodrich, Cleveland, Ohio;

0.55 g Diethanolamine;

1.54 g Melamine resin crosslinker, Cymel 327, Cytec, West Patterson, N.J.; and

0.20 g Wetting agent, Surfynol 440, Air Products & Chemicals, Allentown, Pa.

Laminate strips (4.5 inches by 6 inches, PolyOne vinyl from PolyOne Corp., Winchester, Va.) were coated with adhesive by draw down with a 6 mil draw bar. The laminate strips were air dried for 15-20 minutes followed by a dehydration bake for seven minutes at 70° C. and cooled. The strips were then heated in a 177° C. oven for one minute and immediately placed over a plaque substrate(4 inches by 6 inches) of acrylonitrile-butadiene-styrene (ABS) resin and the assembly was bonded with a Carver press (Carver Press Model 2697) then preheated to 54 to 60° C., with 14.6 pounds per square inch for 11 seconds.

The laminated assemblies thus prepared were placed in a test frame for hanging weight peel resistance at 88° C. as a function of time. A 150 gram weight was clipped onto the laminate sample and permitted to hang at an angle slightly offset from the plane of the laminated assembly. The location of separation between the substrate and the laminate layer was marked initially and the sample placed into an oven at 88° C. The location of the separation was marked again after five hours and the separation distance determined as the distance between the initial and five-hour marks. The test procedure outlined above was also conducted at 85° C. and 60% RH and measurements taken initially and after five hours. For the hanging weight test at both conditions, a sample “passed” if the separation distance was less than 30 mm and “failed” if the trilaminate peeled off or the separation distance was greater than 30 mm.

Storage stability was tested by storing the coated laminate strips at room temperature, and at 43° C., and repeating the Hanging Weight Test Method at 88° C. after one, two, and four weeks. The results are shown in the following Table 2.

TABLE 2

| | Example No. | | | | | | |
|---|---|---|---|---|---|---|---|
| | 1 | | | | | | 7¹¹ |
| | (comparative) | 2 | 3 | 4 | 5 | 6 | (comparative) |
| 85° C. | Pass | Pass | Pass | Pass | Pass | Pass | Fail |
| 60% RH | (4 mm) | (5 mm) | (9 mm) | (2 mm) | (3 mm) | (2 mm) | (peeled |
| | | | | | | | off) |
| Initial | Fail | Pass | Pass | Pass | Pass | Pass | Fail |
| | (35 mm) | (3 mm) | (3 mm) | (9 mm) | (13 mm) | (4 mm) | (peeled |
| | | | | | | | off) |
| 1 Week | Fail | Pass | Pass | Fail | Pass | Pass | Fail |
| | (62 mm) | (5 mm) | (3 mm) | (43 mm) | (9 mm) | (3 mm) | (peeled |
| | | | | | | | off) |
| 2 Week | Fail | Pass | Pass | Fail | Pass | Pass | Fail |
| | (51 mm) | (6 mm) | (5 mm) | (peeled | (4 mm) | (5 mm) | (peeled |
| | | | | off) | | | off) |
| 4 Week | Fail | Pass | Pass | Fail | Pass | Pass | Fail |
| | (peeled | (9 mm) | (9 mm) | (peeled | (4 mm) | (16 mm) | (peeled |
| | off) | | | off) | | | off) |
| 1 Week | Fail | Pass | Pass | Fail | Fail | Pass | Fail |
| | (79 mm) | (16 mm) | (3 mm) | (peeled | (peeled | (4 mm) | (peeled |
| | | | | off) | off) | | off) |
| 2 Week | Fail | Pass | Pass | Fail | Fail | Pass | Fail |
| | (51 mm) | (11 mm) | (19 | (peeled | (peeled | (5 mm) | (peeled |
| | | | mm) | off) | off) | | off) |
| 4 Week | Fail | Pass | Pass | Fail | Fail | Pass | Fail |
| | (peeled | (9 mm) | (26 | (peeled | (peeled | (20 mm) | (peeled |
| | off) | | mm) | off) | off) | | off) |

¹¹Aqueous adhesive prepared as described in Example 2 of WO 98/45366.

The Examples demonstrate the superior peel strength when the aqueous adhesive composition of the present invention is used, compared with a similar composition using butylbenzene sulfonamide as plasticizer (Comparative Example 1) or a plasticizer-free polyurethane-acrylic adhesive (Comparative Example 7).

The present invention has been described with reference to specific details of particular embodiments thereof. It is not intended that such details be regarded as limitations upon the scope of the invention except insofar as and to the extent that they are included in the accompanying claims.

We claim:

1. An aqueous adhesive composition comprising a resinous phase dispersed in an aqueous medium, said resinous phase comprising:
(a) a water dispersible polyurethane;
(b) a polymer comprising residues from one or more vinyl ester monomer; and
(c) a plasticizer selected from the group consisting of polyether containing compounds having the following structures I-IV: 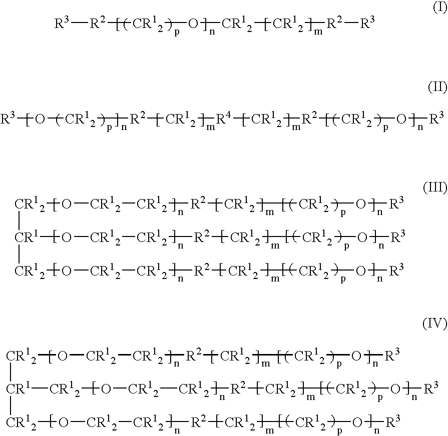
wherein each occurrence of R¹ is independently selected from H, a halide, and C₁-C₈ linear, cyclic, or branched alkyl; each occurrence of R² is independently a linking group selected from a covalent bond, —OCH₂—, —CH₂—, —NH—C(O)—NH—, —NH—C(O)—O—, —NH—C(O)—S—, —C(O)—O—, and —C(O)—NR⁸—, wherein R⁸ is selected from H and C₁-C₄ linear or branched alkyl; each occurrence of R³ is independently selected from H, and C₁-C₂₄ linear, cyclic, or branched alkyl, alkenyl, aryl, alkaryl, and aralkyl; each occurrence of R⁴ is independently selected from a C₁-C₂₄ linear, cyclic, or branched alkylene group, an oxyalkylene group containing from 1 to 24 carbon atoms, a C₁-C₂₄ linear, cyclic, and branched alkylene aryl group, a C₂-C₂₄ linear, cyclic, or branched alkenylene group, a C₂-C₂₄ linear, cyclic, or branched alkynylene group, an oxyalkenylene group containing from 2 to 24 carbon atoms, an oxyalkynylene group containing from 2 to 24 carbon atoms, a C₂-C₂₄ linear, cyclic, or branched alkenylene aryl group, a C₂-C₂₄ linear, cyclic, or branched alkynylene aryl group, a —O—[—(CR¹₂)ₚ—O—]ₙ— group where R¹ is defined as above, and a polyoxyalkylene group having a molecular weight of from 50 to 10,000; n is an integer of from 0 to 1,000; m is an integer from 0 to 6; and p is an integer from 0 to 6.

2. The aqueous adhesive composition of claim 1, wherein the polymer comprising residues of one or more vinyl ester monomers comprises an ethylene-vinyl acetate copolymer.

3. The aqueous adhesive composition of claim 1, further comprising an adjuvant selected from carbodiimide, aziridine and mixtures thereof.

4. The aqueous adhesive composition of claim 1, further comprising a polyfunctional aziridine curing agent.

5. The aqueous adhesive composition of claim 4, wherein the polyfunctional aziridine curing agent is selected from trimethylolpropane-tris-(β-(N-aziridinyl)propionate), pentaerythritol-tetra-(β-(N-aziridinyl)propionate), and mixtures thereof.

6. The aqueous adhesive composition of claim 1, wherein said resinous phase comprises:
(a) 20 to 70 percent by weight of a water dispersible polyurethane;
(b) 1 to 70 percent by weight of a polymer comprising residues of one or more vinyl ester monomers; and
(c) 0.1 to 20 percent by weight of a plasticizer.

7. The aqueous adhesive composition of claim 1, wherein the water dispersible polyurethane has a number average molecular weight of from 1,000 to 50,000 as determined by gel permeation chromatography using polystyrene standards.

8. The aqueous adhesive composition of claim 1, wherein the polymer comprising residues from of one or more vinyl ester monomers has a number average molecular weight of from 1,000 to 50,000 as determined using gel permeation chromatography with polystyrene standards.

9. The aqueous adhesive composition of claim 1, wherein the polyether-containing plasticizer (c) has a number average molecular weight of from 100 to 10,000.

10. The aqueous adhesive composition of claim 1, further comprising N-n-butylbenzenesulfonamide.

11. The aqueous adhesive composition of claim 1, further comprising a rubber-like material selected from the group consisting of polysiloxanes, natural rubber, neoprene, acrylonitrile-butadiene-styrene terpolymer rubber, styrene-butadiene rubber, ethylene-propylene rubber, and nitrile rubber.

12. The aqueous adhesive composition of claim 1, having a Hanging Weight Test Method peel resistance of not more than 30 mm after five hours at 88° C.

13. An aqueous adhesive composition comprising a resinous phase dispersed in an aqueous medium, said resinous phase comprising:
(a) 20 to 70 percent by weight of a water dispersible polyurethane;
(b) 1 to 70 percent by weight of a polymer comprising residues of one or more vinyl ester monomers;
(c) 1 to 10 percent by weight of a plasticizer selected from the group consisting of polyether-containing compounds of structures I-IV: 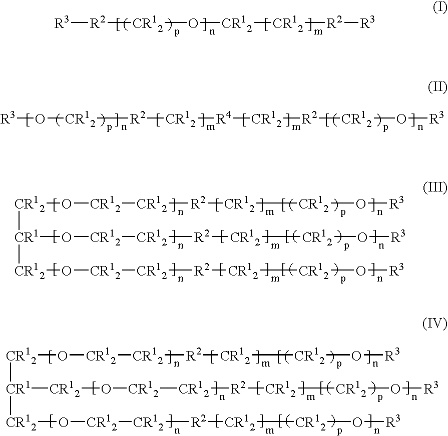
wherein each occurrence of R¹ is independently selected from H, a halide, and C₁-C₈ linear, cyclic, or branched alkyl; each occurrence of R² is independently a linking group selected from a covalent bond, —OCH₂—, —CH₂-, —NH—C(O)—NH—, —NH—C(O)—O—, —NH—C(O)—S—, —C(O)—O—, and —C(O)—NR⁸—, wherein R⁸ is selected from H and C₁-C₄ linear or branched alkyl; each occurrence of R³ is independently selected from H, a halide, and C₁-C₂₄ linear, cyclic, or branched alkyl, alkenyl, aryl, alkaryl, and aralkyl; each occurrence of R⁴ is independently selected from a C₁-C₂₄ linear, cyclic, or branched alkylene group, an oxyalkylene group containing from 1 to 24 carbon atoms, a C₁-C₂₄ linear, cyclic, and branched alkylene aryl group, a C₂-C₂₄ linear, cyclic, or branched alkenylene group, a C₂-C₂₄ linear, cyclic, or branched alkynylene group, an oxyalkenylene group containing from 2 to 24 carbon atoms, an oxyalkynylene group containing from 2 to 24 carbon atoms, a C₂-C₂₄ linear, cyclic, or branched alkenylene aryl group, a C₂ -C₂₄ linear, cyclic, or branched alkynylene aryl group, a —O—[—(CR¹₂)ₚ—O—]ₙ— group where R¹ is defined as above, and a polyoxyalkylene group having a molecular weight of from 50 to 10,000; n is an integer of from 0 to 1,000; m is an integer from 0 to 6; and p is an integer from 0 to 6; and
(d) 0.1 to 10 percent by weight of a curing agent.

14. The aqueous adhesive composition of claim 13, wherein the polymer comprising residues of one or more vinyl ester monomers comprises an ethylene-vinyl acetate copolymer.

15. The aqueous adhesive composition of claim 13, further comprising 0.1 to 10 percent by weight of an adjuvant selected from carbodiimide, aziridine and mixtures thereof.

16. The aqueous adhesive composition of claim 13, wherein the curing agent (d) comprises a polyfunctional aziridine curing agent.

17. The aqueous adhesive composition of claim 13, wherein the curing agent comprises a polyfunctional aziridine curing agent selected from trimethylolpropane-tris-(β-(N-aziridinyl)propionate), pentaerythritol-tetra-(β-(N-aziridinyl)propionate), and mixtures thereof.

18. The aqueous adhesive composition of claim 13, wherein the water dispersible polyurethane has a number average molecular weight of from 1,000 to 50,000 as determined by gel permeation chromatography using polystyrene standards.

19. The aqueous adhesive composition of claim 13, wherein the polymer comprising residues of one or more vinyl ester monomers has a number average molecular weight of from 1,000 to 50,000 as determined using gel permeation chromatography with polystyrene standards.

20. The aqueous adhesive composition of claim 13, wherein the polyether containing plasticizer (c) has a number average molecular weight of from 100 to 10,000.

21. The aqueous adhesive composition of claim 13, further comprising N-n-butylbenzenesulfonamide as a plasticizer.

22. The aqueous adhesive composition of claim 13, further comprising from 0.01 to 5 percent by weight of a rubber-like material selected from the group consisting of polysiloxanes, natural rubber, neoprene, acrylonitrile-butadiene-styrene terpolymer rubber, styrene-butadiene rubber, ethylene-propylene rubber, and nitrite rubber.

23. The aqueous adhesive composition of claim 13, having a Hanging Weight Test Method peel resistance of not more than 30 mm after five hours at 88° C.

24. A multi-layer composite comprising:
(1) a thermoplastic substrate;
(2) an adhesive layer over at least a portion of the substrate; and
(3) a thermoplastic cover layer over at least a portion of the adhesive layer, wherein the adhesive layer is formed from an aqueous adhesive composition comprising a resinous phase dispersed in an aqueous medium, said resinous phase comprising:
(a) a water dispersible polyurethane;
(b) a polymer comprising residues of one or more vinyl ester monomers; and
(c) a plasticizer selected from the group consisting of polyether containing compounds of structures I-IV: 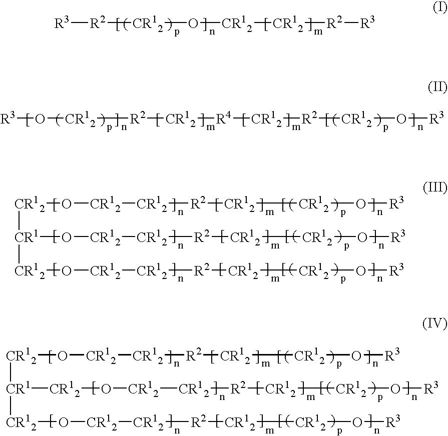
wherein each occurrence of R¹ is independently selected from H, a halide, and C₁-C₈ linear, cyclic, or branched alkyl; each occurrence of R² is independently a linking group selected from a covalent bond, —OCH₂—, —CH₂—, —NH—C(O)—NH—, —NH—C(O) —O—, —NH—C(O)—S—, —C(O)—O—, and —C(O)—NHR⁸—, wherein R⁸ is selected from H and C₁-C₄ linear or branched alkyl; each occurrence of R³ is independently selected from H, a halide, and C₁-C₂₄ linear, cyclic, or branched alkyl, alkenyl, aryl, alkaryl, and aralkyl; each occurrence of R⁴ is independently selected from a C₁-C₂₄ linear, cyclic, or branched alkylene group, an oxyalkylene group containing from 1 to 24 carbon atoms, a C₁-C₂₄ linear, cyclic, and branched alkylene aryl group, a C₂-C₂₄ linear, cyclic, or branched alkenylene group, a C₂-C₂₄ linear, cyclic, or branched alkynylene group, an oxyalkenylene group containing from 2 to 24 carbon atoms, an oxyalkynylene group containing from 2 to 24 carbon atoms, a C₂-C₂₄ linear, cyclic, or branched alkenylene aryl group, a C₂-C₂₄ linear, cyclic, or branched alkynylene aryl group, a —O—[—(CR¹₂)ₚ—O—]ₙ— group where R¹ is defined as above, and a polyoxyalkylene group having a molecular weight of from 50 to 10,000; n is an integer of from 0 to 1,000; m is an integer from 0 to 6; and p is an integer from 0 to 6.

25. The multi-layer composite of claim 24, having a Hanging Weight Test Method peel resistance of not more than 30 mm after five hours at 88° C.

26. The multi-layer composite of claim 24, wherein the substrate (1) is an untreated substrate.

27. The multi-layer composite of claim 24, wherein the substrate (1) comprises acrylonitrile-butadiene-styrene rubber.

28. The multi-layer composite of claim 24, wherein the thermoplastic cover layer (3) comprises poly(vinyl chloride).

29. The multi-layer composite of claim 24, wherein the polymer comprising residues of one or more vinyl ester monomers (b) comprises an ethylene-vinyl acetate copolymer.

30. The multi-layer composite of claim 24, wherein the aqueous adhesive composition further comprises an adjuvant selected from carbodiimide, aziridine and mixtures thereof.

31. The multi-layer composite of claim 24, wherein the aqueous adhesive composition further comprises a polyfunctional aziridine curing agent.

32. The multi-layer composite of claim 31, wherein the polyfunctional aziridine curing agent comprises a polyfunctional aziridine selected from trimethylolpropane-tris-(β-(N-aziridinyl)propionate), pentaerythritol-tetra-(β-(N-aziridinyl)propionate), and mixtures thereof.

33. The multi-layer composite of claim 24, wherein the resinous phase of the aqueous adhesive composition comprises:
(a) 20 to 70 percent by weight of a water dispersible polyurethane;
(b) 1 to 70 percent by weight of a polymer comprising residues of one or more vinyl ester monomers; and
(c) 1 to 10 percent by weight of a plasticizer.

34. The multi-layer composite of claim 24, wherein the water dispersible polyurethane has a number average molecular weight of from 1,000 to 50,000 as determined by gel permeation chromatography using polystyrene standards.

35. The multi-layer composite of claim 24, wherein the polymer comprising residues of one or more vinyl ester monomers has a number average molecular weight of from 1,000 to 50,000 as determined by gel permeation chromatography using polystyrene standards.

36. The multi-layer composite of claim 31, wherein the polyether-containing plasticizer (c) has a number average molecular weight of from 100 to 10,000.

37. The multi-layer composite of claim 31, wherein the aqueous adhesive composition further comprises N-n-butylbenzenesulfonamide as a plasticizer.

38. The multi-layer composite of claim 24, wherein the aqueous adhesive composition further comprises a rubber-like material selected from the group consisting of polysiloxanes, natural rubber, neoprene, acrylonitrile-butadiene-styrene terpolymer rubber, styrene-butadiene rubber, ethylene-propylene rubber, and nitrile rubber.

39. The multi-layer composite of claim 24, wherein the aqueous adhesive composition has a Hanging Weight Test Method peel resistance of not more than 30 mm after five hours at 88° C.

40. A method for adhering a thermoplastic cover material to a thermoplastic substrate comprising:
(1) providing a thermoplastic cover material having a top surface and a bottom surface;
(2) applying an aqueous composition to at least a portion of the bottom surface of the thermoplastic cover material, the composition comprising a resinous phase dispersed in an aqueous medium, said resinous phase comprising:
(a) a water dispersible polyurethane;
(b) a polymer comprising residues of one or more vinyl ester monomers; and
(c) a plasticizer selected from the group consisting of polyether containing compounds of structures I-IV: 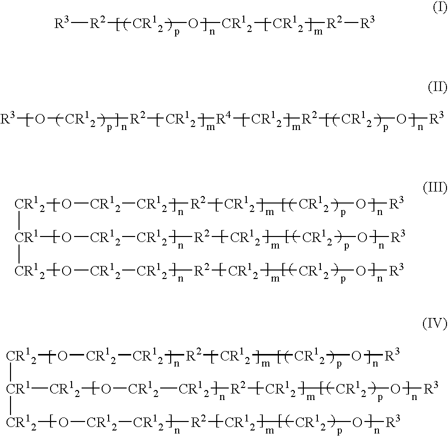
wherein each occurrence of R¹ is independently selected from H, a halide, and C₁-C₈ linear, cyclic, or branched alkyl; each occurrence of R² is independently a linking group selected from a covalent bond, —OCH₂—, —CH₂—, —NH—C(O)—NH—, —NH—C(O)—O—, —NH—C(O)—S—, —C(O)—O—, and —C(O)—NR⁸—, wherein R⁸ is selected from H and C₁-C₄ linear or branched alkyl; each occurrence of R³ is independently selected from H, a halide, and C₁-C₂₄ linear, cyclic, or branched alkyl, alkenyl, aryl, alkaryl, and aralkyl; each occurrence of R⁴ is independently selected from a C₁-C₂₄ linear, cyclic, or branched alkylene group, an oxyalkylene group containing from 1 to 24 carbon atoms, a C₁-C₂₄ linear, cyclic, and branched alkylene aryl group, a C₂-C₂₄ linear, cyclic, or branched alkenylene group, a C₂-C₂₄ linear, cyclic, or branched alkynylene group, an oxyalkenylene group containing from 2 to 24 carbon atoms, an oxyalkynylene group containing from 2 to 24 carbon atoms, a C₂-C₂₄ linear, cyclic, or branched alkenylene aryl group, a C₂-C₂₄ linear, cyclic, or branched alkynylene aryl group, a —O—[—(CR¹₂)_{p—}O—]ₙ— group where R¹ is defined as above, and a polyoxyalkylene group having a molecular weight of from 50 to 10,000; n is an integer of from 0 to 1,000; m is an integer from 0 to 6; and p is an integer from 0 to 6;
(3) drying said composition to form a dried adhesive layer on the bottom surface of the thermoplastic cover material;
(4) heating the thermoplastic cover material of step (3) separate from the substrate;
(5) contacting the adhesive layer on the bottom surface of the thermoplastic cover material to the substrate; and
(6) applying a vacuum to the substrate of step (5) for a time and at a temperature sufficient to adhere the thermoplastic cover material to the substrate.

41. The method of claim 40, wherein the thermoplastic substrate comprises acrylonitrile-butadiene-styrene rubber.

42. The method of claim 40, wherein the thermoplastic cover material is heated to a temperature ranging from 110° C. to 180° C.

43. The method of claim 40, wherein the thermoplastic cover material comprises a vinyl material.

44. The method of claim 40, wherein the polymer comprising residues of one or more vinyl ester monomers in the aqueous adhesive composition comprises an ethylene-vinyl acetate copolymer.

45. The method of claim 40, wherein the aqueous adhesive further comprises an adjuvant selected from carbodiimide, aziridine, and mixtures thereof.

46. The method of claim 40, wherein the aqueous adhesive composition further comprises a polyfunctional aziridine curing agent.

47. The method of claim 46, wherein the polyfunctional aziridine curing agent comprises a polyfunctional aziridine curing agent selected from trimethylolpropane-tris-(β-(N-aziridinyl)propionate), pentaerythritol-tetra-(β-(N-aziridinyl)propionate), and mixtures thereof.

48. The method of claim 40, wherein said resinous phase of said aqueous adhesive comprises:
(a) 20 to 70 percent by weight of a water dispersible polyurethane;
(b) 1 to 70 percent by weight of a polymer comprising residues from a vinyl ester monomer; and
(c) 1 to 10 percent by weight of a plasticizer.

49. The method of claim 40, wherein the water dispersible polyurethane of the aqueous adhesive composition has a number average molecular weight of from 1,000 to 50,000 as determined using gel permeation chromatography with polystyrene standards.

50. The method of claim 40, wherein the polymer comprising residues from a vinyl ester monomer of the aqueous adhesive composition has a number average molecular weight of from 1,000 to 50,000 as determined by gel permeation chromatography using polystyrene standards.

51. The method of claim 40, wherein the polyether containing plasticizer of the aqueous adhesive composition has a number average molecular weight of from 100 to 10,000 as determined using gel permeation chromatography with polystyrene standards.

52. The method of claim 40, wherein the aqueous adhesive composition further comprises N-n-butylbenzenesulfonamide as a plasticizer.

53. The method of claim 40, wherein the aqueous adhesive composition further comprises a rubber-like material selected from the group consisting of polysiloxanes, natural rubber, neoprene, acrylonitrile-butadiene-styrene terpolymer rubber, styrene-butadiene rubber, ethylene-propylene rubber, and nitrile rubber.

54. The method of claim 40, wherein the aqueous adhesive composition has a Hanging Weight Test Method peel resistance of not more than 30 mm after five hours at 88° C.

55. A method for adhering a thermoplastic cover material to a thermoplastic substrate comprising:
(1) applying an aqueous composition to at least a portion of the substrate, the composition comprising a resinous phase dispersed in an aqueous medium, said resinous phase comprising:
(a) a water dispersible polyurethane;
(b) a polymer comprising residues of one or more vinyl ester monomers; and
(c) a plasticizer selected from the group consisting of polyether containing compounds of structures I-IV: 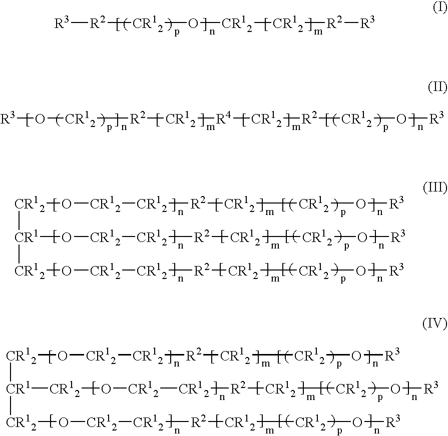
wherein each occurrence of R¹ is independently selected from H, a halide, and C₁-C₈ linear, cyclic, or branched alkyl; each occurrence of R² is independently a linking group selected from a covalent bond, —OCH₂—, —CH₂—, —NH—C(O)—NH—, —NH—C(O)—O—, —NH—C(O)—S—, —C(O)—O—, and —C(O)—NR⁸—, wherein R⁸ is selected from H and C₁-C₄ linear or branched alkyl; each occurrence of R³ is independently selected from H, a halide, and C₁-C₂₄ linear, cyclic, or branched alkyl, alkenyl, aryl, alkaryl, and aralkyl; each occurrence of R⁴ is independently selected from a C₁-C₂₄ linear, cyclic, or branched alkylene group, an oxyalkylene group containing from 1 to 24 carbon atoms, a C₁-C₂₄ linear, cyclic, and branched alkylene aryl group, a C₂-C₂₄ linear, cyclic, or branched alkenylene group, a C₂-C₂₄ linear, cyclic, or branched alkynylene group, an oxyalkenylene group containing from 2 to 24 carbon atoms, an oxyalkynylene group containing from 2 to 24 carbon atoms, a C₂-C₂₄ linear, cyclic, or branched alkenylene aryl group, a C₂-C₂₄ linear, cyclic, or branched alkynylene aryl group, a —O—[—(CR¹₂)ₚ—O—]ₙ— group where R¹ is defined as above, and a polyoxyalkylene group having a molecular weight of from 50 to 10,000; n is an integer of from 0 to 1,000; m is an integer from 0 to 6; and p is an integer from 0 to 6;
(2) drying said composition to form a dried adhesive layer on the substrate;
(3) heating said thermoplastic cover material separate from the substrate;
(4) contacting said thermoplastic cover material to said dried adhesive layer; and
(5) applying a vacuum to the substrate of step (4) for a time and at a temperature sufficient to adhere said thermoplastic cover material to said substrate.

56. The method of claim 55, wherein the thermoplastic substrate comprises acrylonitrile-butadiene-styrene rubber.

57. The method of claim 55, wherein the thermoplastic cover material is heated to a temperature ranging from 110° C. to 180° C.

58. The method of claim 55, wherein the thermoplastic cover material comprises a vinyl material.

59. The method of claim 55, wherein the polymer comprising residues of one or more vinyl ester monomers in the aqueous adhesive composition comprises an ethylene-vinyl acetate copolymer.

60. The method of claim 55, wherein the aqueous adhesive further comprises an adjuvant selected from carbodiimide, aziridine, and mixtures thereof.

61. The method of claim 55, wherein the aqueous adhesive composition further comprises a polyfunctional aziridine curing agent.

62. The method of claim 61, wherein the polyfunctional aziridine curing agent comprises a polyfunctional aziridine curing agent selected from trimethylolpropane-tris-(β-(N-aziridinyl)propionate), pentaerythritol-tetra-(β-(N-aziridinyl)propionate), and mixtures thereof.

63. The method of claim 55, wherein said resinous phase of said aqueous adhesive comprises:
(a) 20 to 70 percent by weight of a water dispersible polyurethane;
(b) 1 to 70 percent by weight of a polymer comprising residues from a vinyl ester monomer; and
(c) 1 to 10 percent by weight of a plasticizer.

64. The method of claim 55, wherein the water dispersible polyurethane of the aqueous adhesive composition has a number average molecular weight of from 1,000 to 50,000 as determined using gel permeation chromatography with polystyrene standards.

65. The method of claim 55, wherein the polymer comprising residues from a vinyl ester monomer of the aqueous adhesive composition has a number average molecular weight of from 1,000 to 50,000 as determined by gel permeation chromatography using polystyrene standards.

66. The method of claim 55, wherein the polyether containing plasticizer of the aqueous adhesive composition has a number average molecular weight of from 100 to 10,000 as determined using gel permeation chromatography with polystyrene standards.

67. The method of claim 55, wherein the aqueous adhesive composition further comprises N-n-butylbenzenesulfonamide as a plasticizer.

68. The method of claim 55, wherein the aqueous adhesive composition further comprises a rubber-like material selected from the group consisting of polysiloxanes, natural rubber, neoprene, acrylonitrile-butadiene-styrene terpolymer rubber, styrene-butadiene rubber, ethylene-propylene rubber, and nitrile rubber.
